(19) United States
(12) Patent Application Publication
(10) Pub. No.: US 2020/0031163 A1
(43) Pub. Date: Jan. 30, 2020

(54) Kit for a Wheel and Blank for Forming a Portion of a Rim of the Wheel

(71) Applicant: Cascade Manufacturing Ltd., MacGregor (CA)

(72) Inventor: Matthew Waldner, MacGregor (CA)

(21) Appl. No.: 16/506,179

(22) Filed: Jul. 9, 2019

Related U.S. Application Data
(60) Provisional application No. 62/702,590, filed on Jul. 24, 2018.

(51) Int. Cl. B60B 21/06; B60B 7/06; B60B 31/04; E02F 9/02

(52) U.S. Cl. CPC B60B 21/066; E02F 9/024; B60B 31/04; B60B 7/063

(57) ABSTRACT

A kit for a wheel comprises a hub component in the form of an annular body defining a central opening for receiving a shaft on which the wheel is to be mounted, at least one outer rim component adapted to form a substantially circular periphery of the wheel and a plurality of spoke components adapted to interconnect the at least one outer rim component and the hub component with each of the spoke components being arranged at a respective angular position about the hub component. Each outer rim component is formable from a blank comprises a main body which defines an outer ground engaging surface of the wheel, a pair of strips consecutively attached to one end of the main body in a manner such that each strip is movable relative to the adjacent element about a transverse folding axis, so that the strips can be folded to define a peak projecting outwardly to form a wheel rim with fins.

This application claims the benefit under 35 U.S.C. 119(e) of U.S. Provisional Application Ser. No. 62/702,590 filed Jul. 24, 2018.

### FIELD OF THE INVENTION

The present invention relates generally to wheels, and more particularly, to kits from which wheels can be assembled, for example wheels of the type used as support wheels for towers of an agricultural irrigation system.

### BACKGROUND

There are a number of industries which use equipment having large diameter wheels, which renders transport or shipping of such wheels difficult due to their size. One example is support wheels of irrigation system towers in the agricultural industry.

### SUMMARY OF THE INVENTION

According to an aspect of the invention there is provided a kit for forming a wheel comprising:

a hub component in the form of an annular body defining a central opening for receiving a shaft on which the wheel is to be mounted;

at least one outer rim component adapted to form a substantially circular periphery of the wheel and defining an inner surface adapted for facing generally radially inwardly of the wheel towards the hub component and opposite to the inner surface, said at least one outer rim component defining an outer surface of the wheel for engaging a ground surface; and

a plurality of spoke components each including at least one leg extending from a first end of a respective one of said at least one leg which is connectable to said at least one outer rim component in proximity of the inner surface thereof to a longitudinally spaced second end of a respective one of said at least one leg which is connectable to the hub component for interconnecting the hub component and said at least one outer rim component, such that the spoke components are adapted to extend generally radially of the wheel between said at least one outer rim component and the hub component each of the spoke components being arranged at a respective angular position about the hub component.

The arrangement herein is particularly designed as a support wheel for an irrigation system where the shaft is an output shaft of a drive gear box for driving all of the wheels from a power supply for moving the irrigation system across the ground on parallel wheels of the type described herein.

This arrangement provides a kit of parts which is better suited for transport or shipping (when disassembled) and from which a wheel can be assembled on site.

In the illustrated arrangements, said at least one outer rim component comprises at least one flange adapted to project generally radially inwardly from the inner surface of said at least one outer rim component to provide a mounting location for connecting the first end of the respective said at least one leg of each spoke component.

In the illustrated arrangements, said at least one outer rim component comprises a central portion extending between longitudinally opposite ends and defining the outer surface and the inner surface, the central portion being bendable in a longitudinal direction thereof, in which the central portion is adapted to follow a circumference of the wheel, from a substantially flat condition suited for shipping to a curved condition in which the central portion forms a curvature adapted to follow the circumference of the wheel.

In the illustrated arrangements, the central portion of said at least one outer rim component comprises a series of planar bodies arranged end to end, adjacent ones of the series of the planar bodies being interconnected by a joining portion defining a transverse bending axis to the longitudinal direction of the central portion so that each one of the planar bodies is movable about the transverse bending axis relative to the next one of the planar bodies.

In the illustrated arrangements, said at least one outer rim component comprises a rim interconnection flange coupled at a first one of the ends of the central portion that is bendable in the longitudinal direction relative to the central portion so as to be adapted to follow the circumference of the wheel, the rim interconnection flange being adapted for overlapping a second one of the ends of the central portion such that the first and second ends of the central portion of said at least one outer rim component are interconnectable to form the periphery of the wheel.

In the illustrated arrangements, each of said at least one outer rim component is interconnected with the hub component by a pair of the spoke components each connected to the respective said at least one outer rim component at a spaced location from the other relative to a width direction of the wheel, and the first and second ends of said at least one leg of a respective one of the pair of the spoke components are offset from one another in a depth direction of the respective spoke component, which is adapted to lie in a width direction of the wheel, so that the second ends of the legs of the pair of the spoke components meet at a common location for subsequently connecting to the hub component.

In one arrangement, the first and second ends of said at least one leg of the respective one of the pair of the spoke components are offset by a different distance in the depth direction thereof so that the hub component is offset from a center of the wheel with respect to the width direction thereof.

In one arrangement, each spoke component is channel-shaped so as to include a base wall and an opposite pair of sidewalls disposed on a common side of the base wall, the base wall being planar and adapted to lie in a radial plane of a rotational axis of the wheel defined at the central opening of the hub component, and the sidewalls each defining an edge generally at the first end of the spoke component that is adapted to abut the inner surface of said at least one outer rim component and to extend in the width direction of the wheel from a generally central location on the inner surface to a side of said at least one outer rim component.

Preferably, the base wall also defines an edge generally at the first end of the spoke component that is adapted to abut the inner surface of said at least one outer rim component.

Preferably, the sidewalls are adapted to extend in both the width direction of the wheel and a circumferential direction of the wheel such that the edges of the sidewalls are also adapted to extend in the circumferential direction of the wheel in abutment with the inner surface of said at least one outer rim component.

In one arrangement, each spoke component of the pair interconnecting each of said at least one outer rim component and the hub component is adapted to be angularly offset from the other one of said pair of spoke components about the central opening of the hub component. In this manner, each circumferentially adjacent pair of connection locations of the at least one outer rim component are connected to a spoke component.

In one arrangement, said at least one outer rim component is adapted to form one or more outwardly-projecting triangular fins extending in a width direction of the wheel and spaced from one another in a circumferential direction of the wheel, each fin defining an interior void which is open adjacent the inner surface of said at least one outer rim component so as to be adapted to open to an interior of the wheel, and the first end of each spoke component, which is connectable to said at least one outer rim component, defines a tab adapted for matable insertion into the void to support the fin.

According to another aspect of the invention there is provided a blank for forming a circumferential portion of a rim of a wheel, the rim having outwardly projecting fins extending in a width direction of the wheel, the blank comprising:

a main body having opposite longitudinally spaced apart ends and transversely spaced apart sides interconnecting the opposite ends, the main body defining an outer surface for engaging a ground surface;

a first transversely oriented strip connected at one of the ends of the main body in a manner defining a transverse folding axis about which the first strip is movable relative to the main body;

a second transversely oriented strip connected to the first strip opposite to the main body in a manner defining a transverse folding axis about which the second strip is movable relative to the first strip;

each of the first and second strips carrying tabs at transversely spaced positions thereon, each tab being foldable relative to a respective one of the first and second strips about a substantially longitudinally oriented folding axis;

a generally triangularly shaped cut-out being formed between a first one of the tabs on the first strip and a first one of the tabs on the second strip that are adjacent, which is partially delimited by opposing edges of the first tabs of the first and second strips, such that in a folded rim-forming condition of the blank in which the first and second strips are positioned to form a peak such that an outer surface of the first strip is inclined outwardly from the outer surface of the main body, such that one of the fins is formed thereby, and in which condition the tabs are positioned substantially perpendicularly to an inner surface of a respective one of the first and second strips, said opposing edges are positioned facing one another so as to be adapted to engage one another.

The tabs on the strips may act to define a smallest possible interior angle of the peak which forms the fin and may provide structural reinforcement against compressive forces acting on the fin so formed.

In the illustrated arrangement, the main body carries tabs at transversely spaced positions thereon which are foldable relative to the main body about substantially longitudinally oriented folding axes, each tab carried on the main body having edges which follow portions of triangularly shaped peripheries of the tabs carried on the first strip that are opposite from a respective one of the opposing edges defined by the tabs on the first strip, and each tab carried on the main body locating an aperture which is adapted to lie generally radially in-line with the tabs carried on the first strip when the tabs carried on the main body are positioned substantially perpendicularly to an opposite inner surface of the main body for receiving a fastener to interconnect the blank arranged in the folded rim-forming condition with another component of the wheel.

In the illustrated arrangement, there is provided first and second sets of the main body with the tabs, the first strip with the tabs and the second strip with the tabs, the main body of the first set being connected to the second strip of the second set opposite to the first strip of the second set in a manner defining a transverse folding axis about which the main body of the first set is movable relative to the second strip of the second set, each tab carried on the main body of the first set having edges which follow portions of triangularly shaped peripheries of the tabs carried on the second strip of the second set that are opposite from a respective one of the opposing edges defined by the tabs on the second strip of the second set, and distal edges of the tabs carried on the main body of the first set that are respectively adjacent the periphery-following edges thereof being adapted for engaging distal edges of the tabs carried on the main body of the second set that are respectively adjacent the periphery-following edges thereof in the folded rim-forming condition of the blank, in which the tabs carried on the main body of the first and second set are positioned substantially perpendicularly to the inner surface of the corresponding main body, so that the distal edges of the tabs carried on a respective one of the main bodies of the first and second sets are positioned facing one another so as to be adapted to engage one another.

In the illustrated arrangement, the kit further includes a transversely oriented rim interconnection flange which is connected to the second strip of the first set opposite to the first strip of the first set in a manner defining a transverse folding axis about which the rim interconnection flange is movable relative to the second strip of the first set, the rim interconnection flange being adapted to overlap a free end of a main body of another like blank for facilitating interconnection of a plurality of the blanks to form the rim of the wheel.

### BRIEF DESCRIPTION OF THE DRAWINGS

The invention will now be described in conjunction with the accompanying drawings in which:

FIG. 1 is a perspective view of kit according to an arrangement of the present invention, which is shown in an assembled condition forming a wheel of the type having outwardly projecting fins extending in a width direction of the wheel;

FIG. 2 is a perspective view of outer rim component of the kit of FIG. 1;

FIG. 3 is a side elevational view of the outer rim component of FIG. 2;

FIG. 4 is an elevational view from an outer side of the outer rim component of FIG. 2;

FIG. 5 is an elevational view from an inner side of the outer rim component of FIG. 2 but shown in a substantially flat or unfolded condition;

FIG. 6 is a perspective view of spoke component of the kit of FIG. 1;

FIG. 7 is a side elevational view of the spoke component of FIG. 6;

FIG. 8 is an end view of the spoke component of FIG. 6;

FIG. 9 is an end view of a variant of the spoke component of FIG. 6 having a different offset between opposite ends;

FIG. 10 is a perspective view of hub component of the kit of FIG. 1;

FIG. 11 is a side elevational view of the hub component of FIG. 10;

FIG. 12 is an elevational view from an outer side of the wheel of FIG. 1;

FIG. 13 is an elevational view from an inner side of the wheel of FIG. 1;

FIG. 14 is an end view showing a 180 degree span of the wheel of FIG. 1 from a peak of one fin to that of a diametrically opposite fin;

FIG. 15 is an end view like that in FIG. 14 but showing in dotted line the elements which are otherwise hidden from view in FIG. 14;

FIG. 16 is a first perspective view of a second arrangement of kit according to the present invention shown in an assembled condition forming a wheel of the type having outwardly projecting fins extending in a width direction of the wheel, and it will be appreciated that fasteners are omitted for clarity of illustration;

FIG. 17 is a second perspective view of the wheel of FIG. 16;

FIG. 18 is a side elevational view of the wheel of FIG. 16;

FIG. 19 is a cross-sectional view along line 19-19 in FIG. 18;

FIG. 20 is an end view showing a 180 degree span of the wheel of FIG. 16 from a peak of one fin to that of a diametrically opposite fin;

FIG. 21 is a plan view of spoke component of the kit of FIG. 16;

FIG. 22 is a side elevational view of the spoke component of FIG. 21;

FIG. 23 is an end view of the spoke component of FIG. 21;

FIG. 24 is a plan view of the spoke component of FIG. 21 shown in a substantially flat or unfolded condition;

FIG. 25 is a side elevational view of a variant of the spoke component of FIG. 21 having a different offset between opposite ends;

FIG. 26 is an end view of the variant of the spoke component of FIG. 25;

FIG. 27 is a perspective view of outer rim component of the kit of FIG. 16;

FIG. 28 is an elevational view from an inner side of the outer rim component of FIG. 27 but shown in a substantially flat or unfolded condition;

FIG. 29 is a side elevational view of the outer rim component of FIG. 27; and

FIG. 30 is an elevational view from an outer side of the outer rim component of FIG. 27.
In the drawings, like characters of reference indicate corresponding parts in the different figures.

FIGS. 31-38 to show and describe a new, original and ornamental design for a WHEEL which is also claimed herein. More specifically:

FIG. 31 is a perspective view of a first embodiment of the WHEEL showing the new design;

FIG. 32 is a first side elevational view thereof;

FIG. 33 is a second side elevational view thereof; and

FIG. 34 is an end view showing a 180 degree span thereof.
The opposite end view of the first embodiment of the WHEEL is identical to FIG. 34.

FIG. 35 is a first perspective view of a second embodiment of the WHEEL showing the new design;

FIG. 36 is a second perspective view from the same side of the second embodiment of the WHEEL;

FIG. 37 is a side elevational view of the second embodiment of the WHEEL; and

FIG. 38 is an end view showing a 180 degree span thereof.
The opposite end view of the second embodiment of the WHEEL is identical to FIG. 38.
The opposite side elevational view of the second embodiment of the WHEEL is substantially identical to FIG. 37.

### DETAILED DESCRIPTION

The accompanying figures show two arrangements of a kit of components forming a wheel 1 of the type having outwardly projecting fins 3 extending in a width direction of the wheel 1. The kit of components, which will be described in further detail shortly, is suited for shipping in an unassembled condition, such that the wheel 1 is assemblable from the kit on site.

The kit comprises:

(1) a hub component 12 in the form of an annular body defining a central opening 14 for receiving a shaft (not shown) on which the wheel is to be mounted;

(2) at least one outer rim component 16 adapted to form a substantially circular periphery of the wheel and defining an inner surface 18 adapted for facing generally radially inwardly of the wheel towards the hub component 12 and opposite to the inner surface 18 the outer rim component 16 defining an outer surface 20 of the wheel for engaging a ground surface; and

(3) a plurality of spoke components 22 each including at least one leg 25 extending from a first end 26 of the leg which is connectable to the outer rim component 16 in proximity of the inner surface 18 thereof to a longitudinally spaced second end 28 of the leg which is connectable to the hub component 12 for interconnecting the hub component 12 and the outer rim component(s) 16, such that the spoke components 22 are adapted to extend generally radially of the wheel between the outer rim component(s) and the hub component 12 with each of the spoke components being arranged at a respective angular position about the hub component 12.

Thus, components of the above three mentioned types can be interconnected so as to form the wheel.

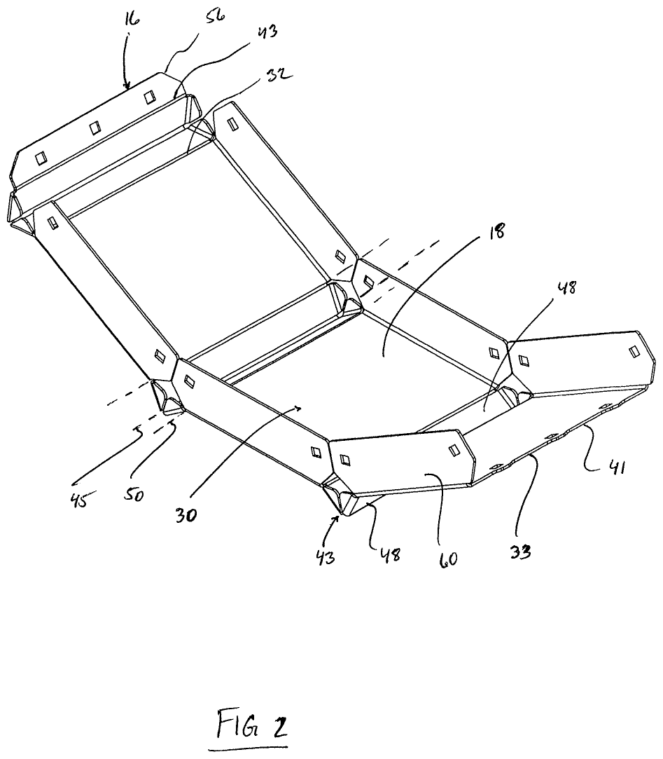

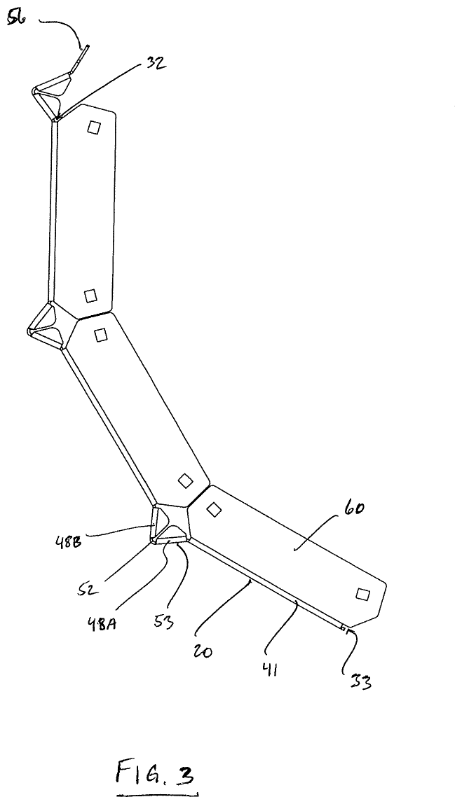

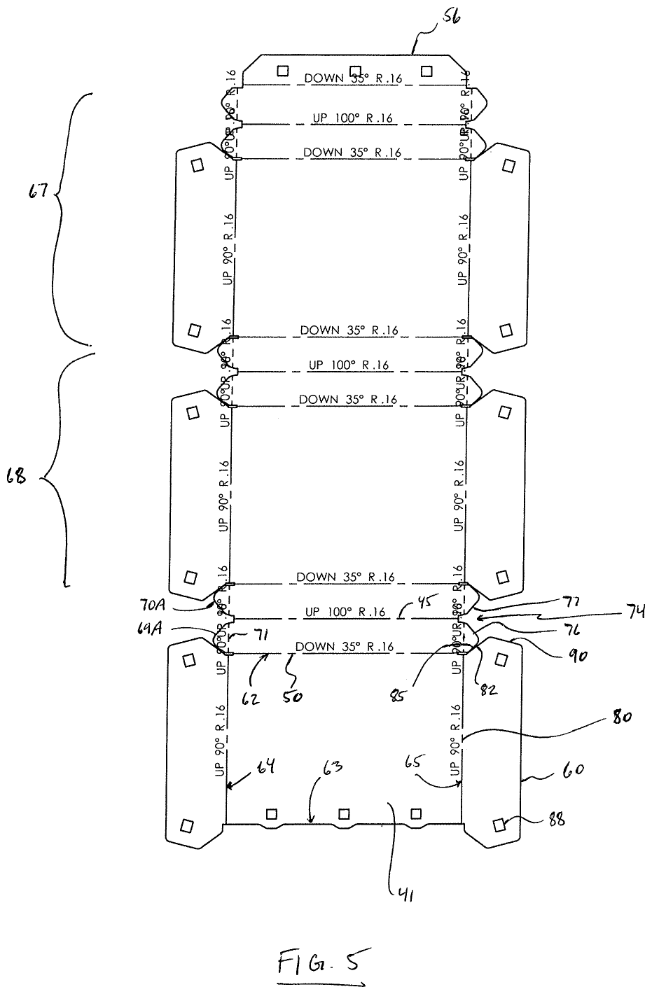

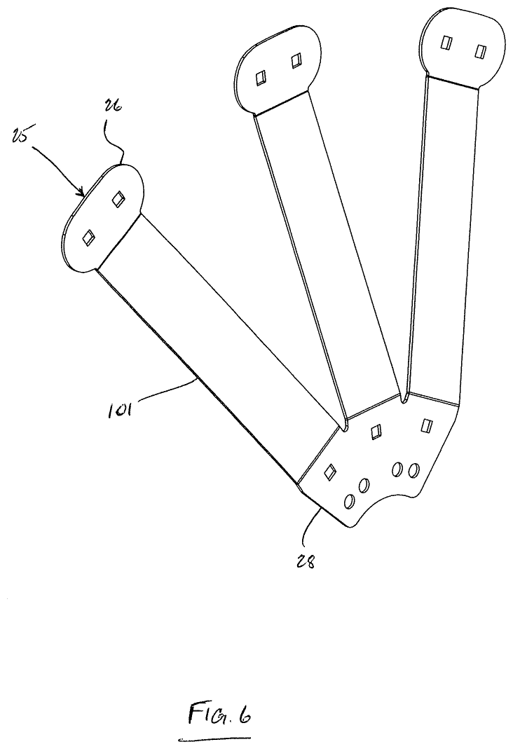

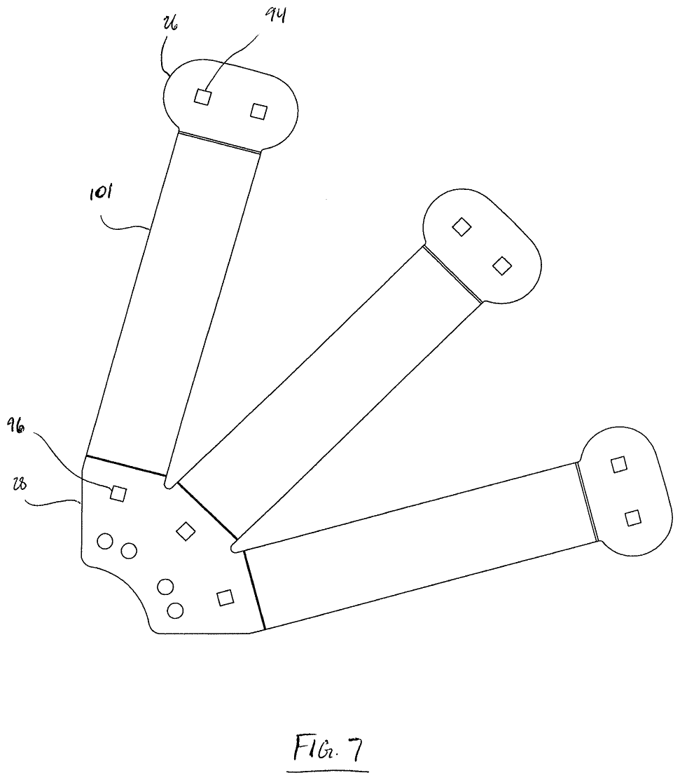

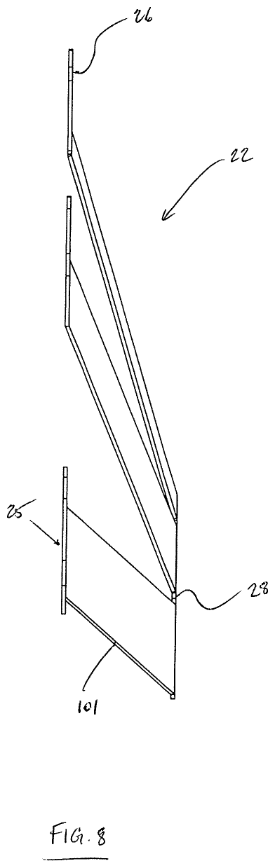

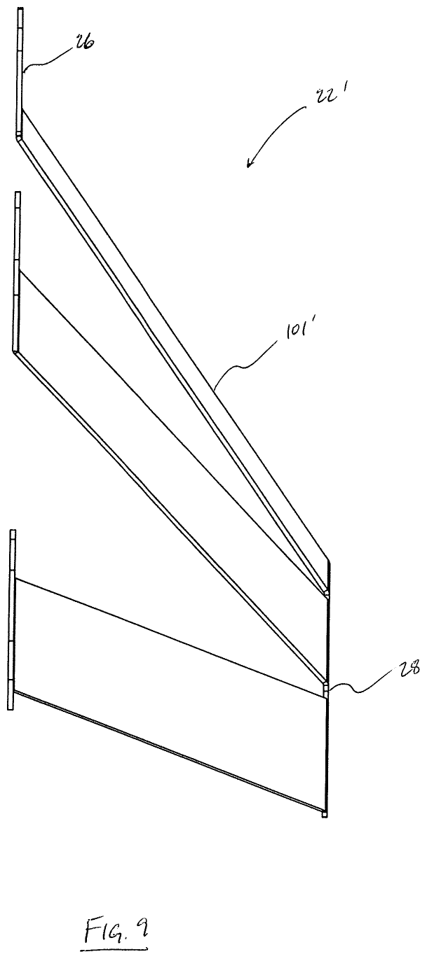

Referring to FIGS. 2 to 5, the outer rim component 16 comprises a central portion 30 which extends between longitudinally opposite ends 32, 33 and defines the outer surface 20 and the inner surface 18. The central portion 30 also extends between transversely opposite sides 35, 36 which are adapted to be arranged at inner and outer sides 37, 38 of the wheel (FIG. 15). That is, the central portion 30 of the outer rim component 16 is adapted to substantially define a width of the wheel 1 and is adapted to be oriented substantially normally to a radial direction of the wheel.

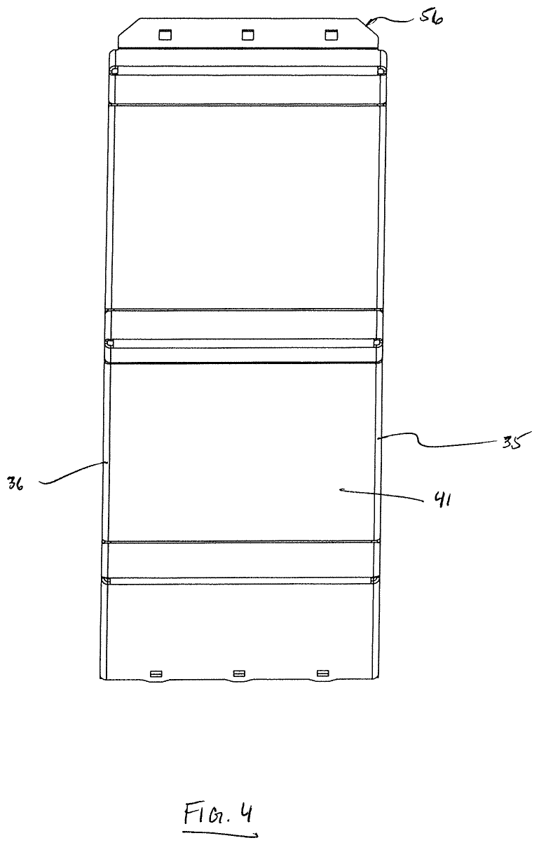

The outer rim component's central portion 30 comprises a series of planar bodies 41 arranged end to end, each adjacent pair thereof being interconnected by a joining portion 43 defining a transverse bending axis 45 to a longitudinal direction of the central portion 30 so that each one of the planar bodies 41 is movable about the adjacent transverse bending axis 45 relative to the next one of the planar bodies in order to form the prescribed curvature to follow the wheel circumference. As such, the central portion 30 is bendable in the longitudinal direction thereof, in which the central portion 30 is adapted to follow a circular circumference of the wheel 1, from a substantially flat condition as shown in FIG. 5 which is suited for shipping to a curved condition in which the central portion 30 forms a curvature as more clearly shown in FIG. 3, and which is adapted to follow the circumference of the wheel 1. In the illustrated arrangements, the planar bodies 41 are formed by plates which are rectangular in shape.

The joining portion 43 comprises a series of planar bodies, which are separately indicated 48A, 48B for convenient reference hereinafter, that are shorter in length in the longitudinal direction than the main planar bodies 41 and are interconnected between adjacent ones of the main bodies 41. Each bridging body 48A, 48B which is connected to one of the main bodies 41 is connected thereto in such a manner as to define a transverse folding axis 50, such that the bridging body 48A, 48B is movable relative to the adjacent main body about this axis 50. Adjacent bridging bodies 48A, 48B are also interconnected in a manner as to define a transverse bending axis, which in the illustrated arrangements is axis 45 as there are only two bridging bodies indicated at 48A and 48B forming each joining portion 43.

The bridging bodies 48A, 48B of the joining portion 43 are adapted for form a peak 52 such that an outer surface 53 of each bridging body 48A, 48B which is adjacent one of the main bodies 41 is inclined outwardly from the outer surface 20 of the respective main body 41, such that one of the fins 3 is formed by the joining portion 43 so arranged. The main bending axis 45 is disposed intermediate adjacent main bodies 41 and coincides with the peak 52. Thus, in the curved condition of the outer rim component 16, the joining portion 43 is additionally arranged as to form the peak 52.

The outer rim component 16 additionally comprises a rim interconnection flange 56 coupled at a first one of the ends of the central portion 30, which is indicated at 32, that is bendable in the longitudinal direction relative to the central portion 30 so as to be adapted to follow the circumference of the wheel. In the illustrated arrangements, the interconnection flange 56 is coupled to the adjacent main body 41 of the central portion 30 via a joining portion 43 as described above. Thus, one of the fins 3 is formable between each adjacent pair of the outer rim components that are joined together. The rim interconnection flange 56 forms another planar body which is shorter in length than the main body 41, as are the bridging bodies 48A, 48B. The rim interconnection flange 56 is adapted for overlapping a second one of the ends of the central portion 30, which is indicated at 33, such that the first and second ends 32, 33 of the central portion 30 of the outer rim component are interconnectable to form the periphery of the wheel 1. Specifically, the interconnection flange 56 overlaps the inner surface 18 of the main body 41 of the central portion 30 of the circumferentially adjacent outer rim component 16. Registrable apertures are defined in each of the flange 56 and the adjacent rim component's main body 41 so that interconnecting fasteners can be passed therethrough.

Thus, as will be appreciated, in the illustrated arrangements the outer rim component 16 is sized to span only a portion of the circumference of the wheel 1, such that a plurality of the outer rim components 16 are interconnected to form the rim of the wheel.

For connecting to the spoke components, each outer rim component 16 comprises at least one spoke coupling flange 60 adapted to project generally radially inwardly from the inner surface 18 of the one outer rim component 16 to provide a mounting location for connecting the first end 26 of the respective leg of each spoke component. The respective spoke coupling flange 60 locates apertures through which fasteners can be passed to interconnect the outer rim component 16 and one of the spoke components 22. Typically, as is provided in the illustrated arrangements of the kit, there are provided a pair of the spoke coupling flanges 60 oriented longitudinally of the central portion 30 and disposed at the opposite sides 35, 36 thereof. More specifically, each main body 41 has a pair of the spoke coupling flanges 60 which are distinct from those of the next main body 41.

The outer rim component, which forms a circumferential portion of the wheel rim, is formed from a blank comprising:

(i) a main body 41 having opposite longitudinally spaced apart ends 62, 63 and transversely spaced apart sides 65, 66 interconnecting the opposite ends 62, 63, the main body 41 defining an outer surface 20 for engaging a ground surface—this corresponds to the respective main body of the afore-described central portion 30 of the outer rim component;

(ii) a first transversely oriented strip 48A connected at one of the ends 62 of the main body 41 in a manner defining a transverse folding axis 50 about which the first strip 48A is movable relative to the main body 41—this corresponds to one of the bridging bodies of the afore-described joining portion 43 of the outer rim component; and

(iii) a second transversely oriented strip 48B connected to the first strip 48A opposite to the main body 41 in a manner defining a transverse folding axis 45 about which the second strip 48B is movable relative to the first strip 48A—this corresponds to a second one of the bridging bodies of the afore-described joining portion 43.

As more clearly shown in FIG. 5, the blank of the first illustrated arrangement comprises multiple sets including first and second sets 67, 68 of the main body 41, the first strip 48A and the second strip 48B, where the main body 41 of the first set 67, for example, is connected to the second strip 48B of the second set 68 opposite to the first strip 48A of that set 68 in a manner defining a transverse folding axis 50 about which the main body 41 of the first set 67 is movable relative to the second strip 48B of the second set 68.

Further, each of the first and second strips 48A, 48B carry reinforcing tabs 69A-B and 70A-B at transversely spaced positions thereon, where each reinforcing tab 69A-B, 70A-B is foldable relative to the corresponding strip about a substantially longitudinally oriented folding axis 71. For convenient reference hereinafter, the first strip 48A carries tabs 69A and 70A, and the second strip 48B carries tabs 69B and 70B.

A generally triangularly shaped cut-out 74 is formed between a first one of the tabs 69A on the first strip 48A and a first one of the tabs 69B on the second strip 48B that are adjacent, which cut-out 74 is partially delimited by opposing edges 76, 77 of the first tabs 69A-B of the first and second strips. Thus in a folded rim-forming condition of the blank in which the first and second strips are positioned to form a peak 52 such that an outer surface 53 of the first strip 48A is inclined outwardly from the outer surface 20 of the main body 41, such that one of the fins is formed thereby, and in which condition the tabs 69A-B, 70A-B are positioned substantially perpendicularly to an inner surface 79 of the corresponding strip 48A, 48B, the opposing edges 76, 77 are positioned facing one another so as to be adapted to engage one another. The tabs on the strips may act to define a smallest possible interior angle of the peak which forms the fin 3 (and thus the sharpest or steepest fin) and may provide structural reinforcement against compressive forces acting on the fin so formed.

Additionally, a transversely oriented rim interconnection flange 56, corresponding to the afore-described rim interconnection flange 56, which is connected to the second strip 48B of the first set 67 opposite to the first strip 48A of the first set 67 in a manner defining a transverse folding axis 50 about which the rim interconnection flange 56 is movable relative to the second strip 48B of the first set 67. The rim interconnection flange 56 is adapted to overlap a free end of a main body 41 of another like blank for facilitating interconnection of a plurality of the blanks to form the rim of the wheel.

The main body 41 of the blank carries coupling tabs 60 at transversely spaced positions thereon which are foldable relative to the main body 41 about substantially longitudinally oriented folding axes 80—this corresponds to the afore-described spoke coupling flanges 60. Each coupling tab 60 has opposite edges 82 proximal to the main body 41 to which they are attached, and which edges 82 terminate thereat, that follow portions 85 of triangularly shaped peripheries of the reinforcing tabs 69A-B, 70A-B which are opposite from the corresponding one of the opposing edges 76, 77 defined by the reinforcing tabs. Each coupling tab 60 locates an aperture 88 which is adapted to lie generally radially in-line with the reinforcing tabs of the corresponding strip adjacent the main body 41 on which the respective coupling tab is carried when positioned substantially perpendicularly to the inner surface 18 of the main body 41, as more clearly shown in FIG. 3, for receiving a fastener to interconnect the blank arranged in the folded rim-forming condition with another component of the wheel, namely one of the spoke components 22.

Furthermore, referring to FIG. 5, end edges 90 of the coupling tabs 60 that are respectively adjacent the periphery-following proximal edges 82, and thus distal to the main body 41 to which the respective coupling tab 60 is attached, are adapted for engaging distal end edges 90 of the coupling tabs carried on the main body of the second set that are respectively adjacent the periphery-following edges 82 thereof in the folded rim-forming condition of the blank, in which the coupling tabs 60 of the main bodies 41 of adjacent sets are respectively positioned substantially perpendicularly to the inner surface 18 of the corresponding main body, so that the distal edges 90 of the coupling tabs 60 of the adjacent sets' main bodies are positioned facing one another so as to be adapted to engage one another, as more clearly shown in FIG. 3. This engagement of edges 90 may act to strengthen the rim of the wheel so formed from a folded blank, particularly at locations thereon which are angularly aligned with the fins 3 where there is not much strength at the fins formed from folded elements.

Referring to FIGS. 6 to 9, each spoke component 22 comprises a plurality of the legs 25 extending from separated first ends 26 of the legs 25 which are connected with the coupling tabs 60 of the outer rim component(s) 16 to interconnected second ends 28 of the legs 25, so as to form a common inner end of all the legs of the respective spoke component, which is connected with the hub component 12. The separated first ends 26 of the legs 25 are thus adapted to form an outer end of the respective spoke component relative to a radial direction of the wheel 1.

The first end 26 of each leg 25 carries at least one aperture 94 and is connected to the respective outer rim component 16 by arrangement in an overlapping condition with the coupling tab 60 carried on the main body 41 of outer rim component 16. A fastener is passed through registrable aperture 88, 94 in the overlapped elements to interconnect the same. In the first illustrated arrangement, each leg 25 interconnects the main bodies 41 of adjacent sets, such as 67 and 68, of the respective outer rim component 16. Furthermore, each leg 25 is adapted to be substantially located in angular alignment with the respective projecting fin 3 of the wheel 1.

The second end 28 of each leg 25 also carries at least one aperture 96 and is connected to the hub component 12 by arrangement generally in an overlaid condition with the hub component 12, which will be described in further detail shortly. A fastener is passed through registrable openings 96 and that indicated at 98 to interconnect the spoke component 22 and the hub component 12.

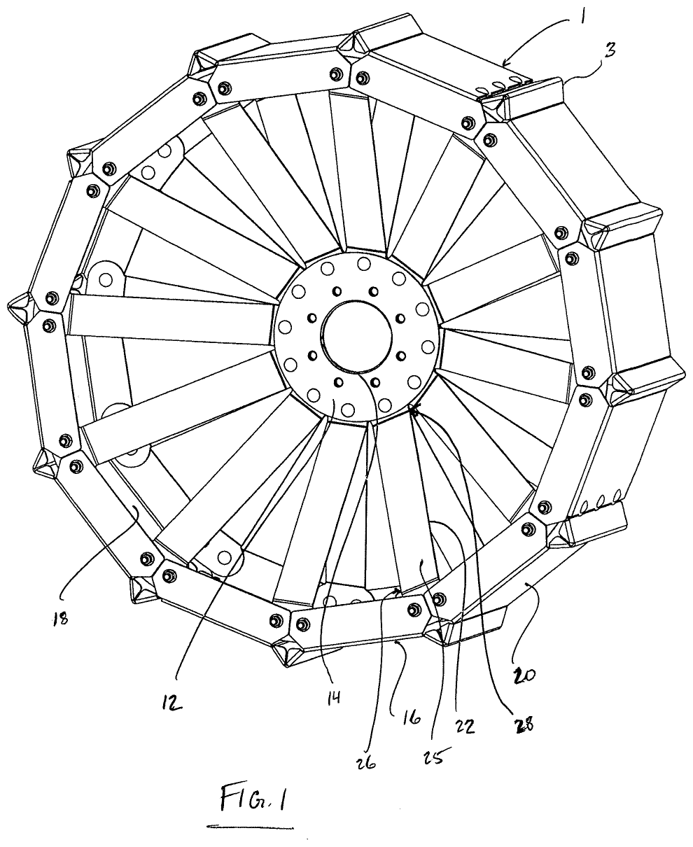

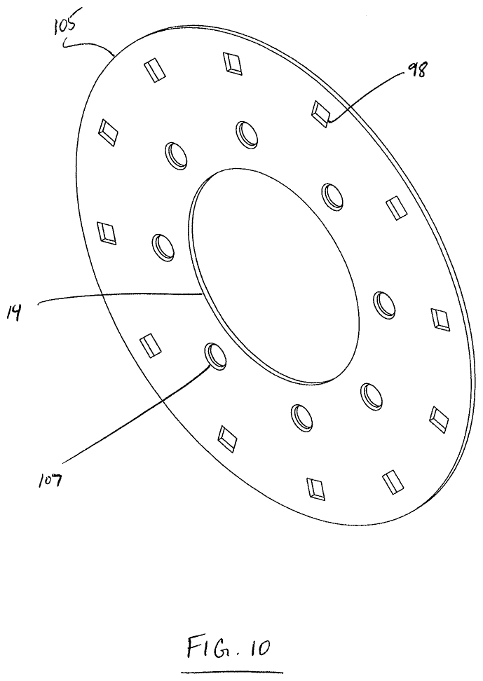

Each leg 25 comprises opposite planar end portions defining the opposite ends 26, 28 which are interconnected by an elongate intermediary portion 101 adapted to extend radially of the wheel 1. As more clearly shown for example in FIG. 8, the intermediary portion 101 forms a planar bar which is inclined in orientation to each of the ends 26, 28, each of which defines a distinct parallel plane to the other which is spaced from the other in a depth direction of the respective spoke component. Thus, the opposite ends 26, 28 of each leg 25 are offset from one another in the depth direction of the respective spoke component, which is adapted to lie in the width direction of the wheel. Since in the illustrated arrangements a pair of complementary spoke components interconnect each outer rim component 16 with the hub component 12 at transversely spaced locations on the respective outer rim component 16, that is, at spaced locations from one another relative to the width direction of the wheel, as shown more clearly in FIG. 1, the offsetting of the opposite ends 26, 28 of the legs 25 allows the inner ends 28 of the legs of the pair of the spoke components to meet at a common location relative to the width of the wheel for subsequently connecting to the hub component 12. Yet further, for each pair of complementary cooperating spoke components shown in FIGS. 8 and 9 and indicated at 22 and 22′ interconnecting a common outer rim component with the hub component, the opposite ends 26, 28 of their legs are offset by a different distance in the depth direction thereof so that the hub component 12 is offset from a center of the wheel with respect to the width direction thereof, that is, the hub component 12 can be located at an offset position from the wheel center relative to the wheel width, as more clearly shown in FIG. 15.

That is, both variants of the spoke component 22, 22′ which are used on a common wheel 1 are adapted to span the same radial distance from the outer rim component 16 to the hub component 12 but have different length of intermediary portion 101 so that the opposite ends 26, 28 are spaced by a different amount in the depth direction, and likewise the angle formed between the intermediary portion 101 and the respective one of the ends 26, 28 is varied so that each spoke component couples in a like manner with the outer rim component and the hub component. As such, in each pair of complementary spoke components, that indicated at 22 which is located on an outer side of the wheel 1, that is, on an outwardly facing side of the wheel facing away from vehicle on which the wheel is mounted so as to be readily exposed, has a smaller offset between its ends 26, 28 than the spoke component 22′ which is disposed on an inner side 37 of the wheel 1 opposite from the vehicle on which it is mounted, such that the hub component 12 can be located closer to the outer side 38 of the wheel than the inner side 37.

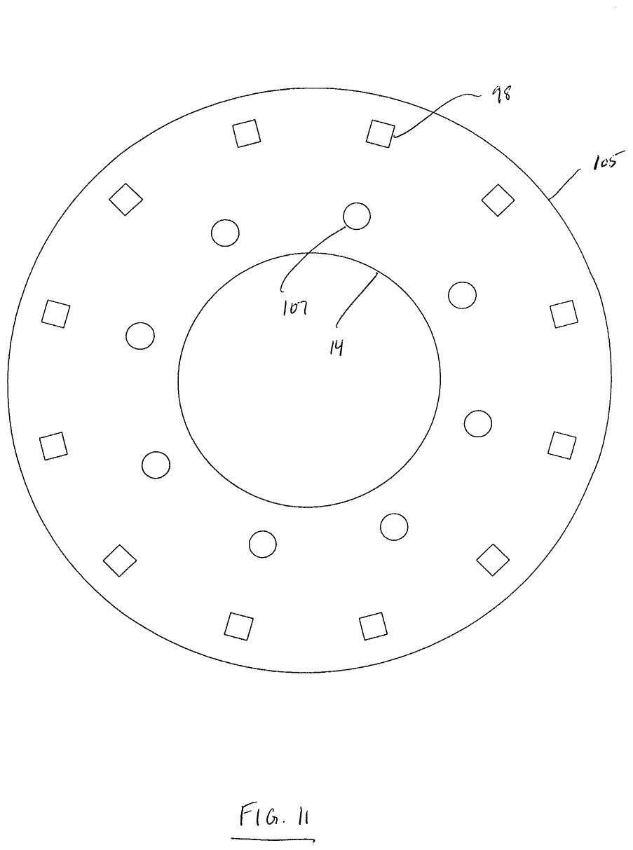

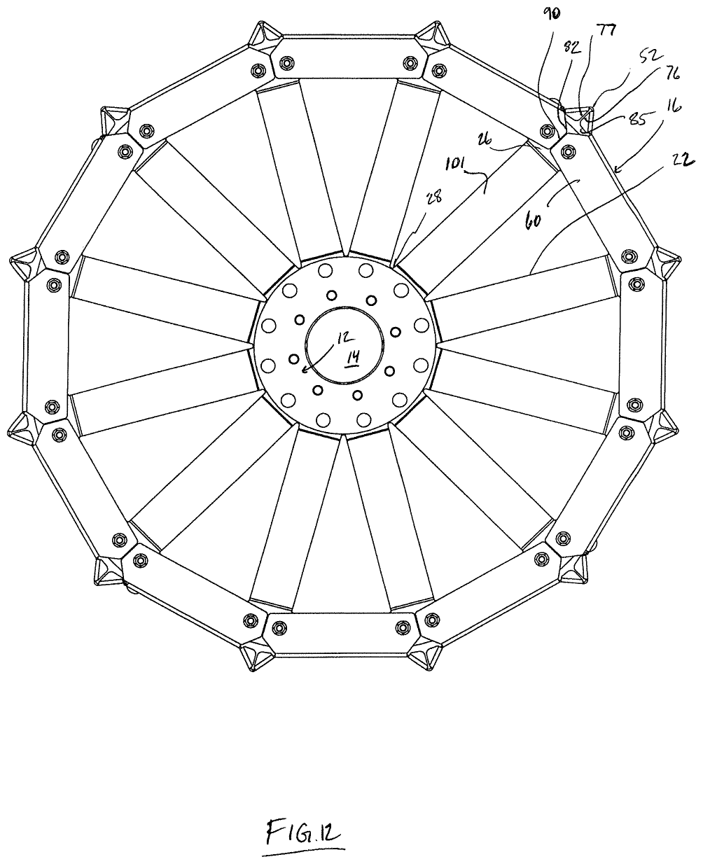

Referring to FIGS. 10 and 11, the hub component 12 comprises a disc-shaped plate 105 of uniform thickness with the central shaft-receiving opening 14 defined in its center. The plate 105 also defines a plurality of apertures 98 at angularly spaced positions around the central opening 14 that are adapted to register with mounting holes 96 defined in the second ends 28 of the legs 25 of the spoke components 22, 22′. The plate 105 also locates shaft-mounting apertures 107 for mounting the wheel onto the shaft (not shown) received through the central opening 14.

In the illustrated arrangements, the hub component is a single disc 105 which is coupled to the inner second ends 28 of the spoke components 22, 22′ in an overlaid arrangement therewith. More specifically, the disc 105 is located in overlaid abutment with an outer side of the outer one of the spoke components 22, which is located in overlaid abutment with the inner one of the spoke components 22′. Thus, the hub component is exposed on the outer side of the wheel 1 and is overlapped with the outer spoke component 22 which is overlapped with the inner spoke component 22′. A common set of fasteners interconnects the single disc of the hub component with the two complementary variants of the spoke components 22, 22′. Also, the spoke components of a common variant 22 or 22′ are each connect at respective angular positions about the hub component 12 which acts as a common mounting location for all spoke components in the vicinity of the wheel center.

Thus, the kit is suited for shipping as the outer rim component 16 can be arranged in a substantially flat condition, the hub component comprises a single flat component in the form of the disc 105 and the spoke components 22, 22′ though having depth-offset ends still occupy relatively minimal space. The kit can be transported in an unassembled condition and then on site the various parts are assemblable to form the wheel 1, which includes folding of the outer rim component to yield the curvature and the fins 3 for interconnecting one outer rim component with the next arranged on one side thereof relative to a circumferential direction of the wheel 1. The spoke components 22, 22′ may then be fastened on an inner side of the coupling tabs 60 and overlapped with one another at the wheel center in a condition ready to receive the hub component placed on the outer side of the outer spoke component 22.

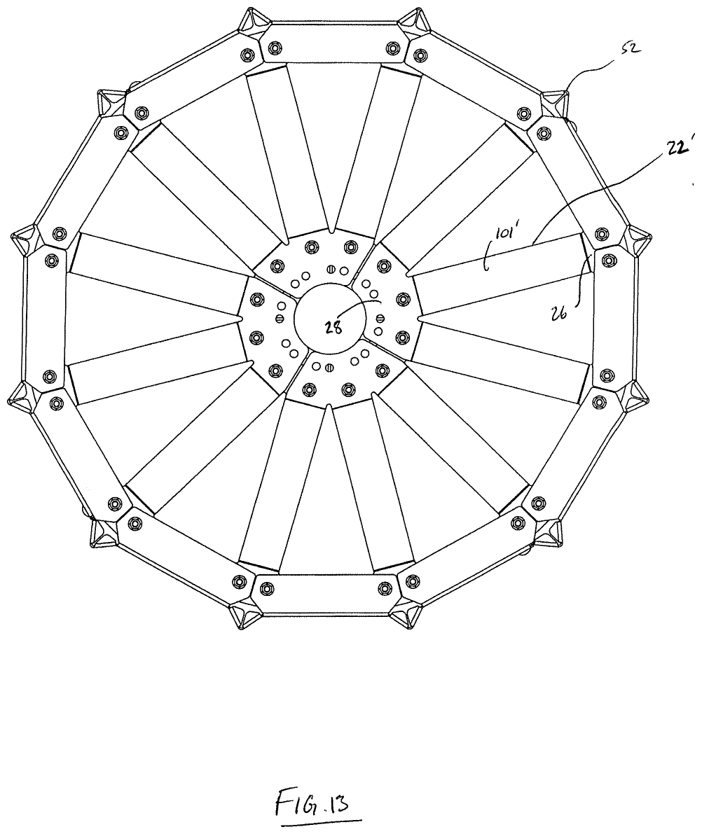

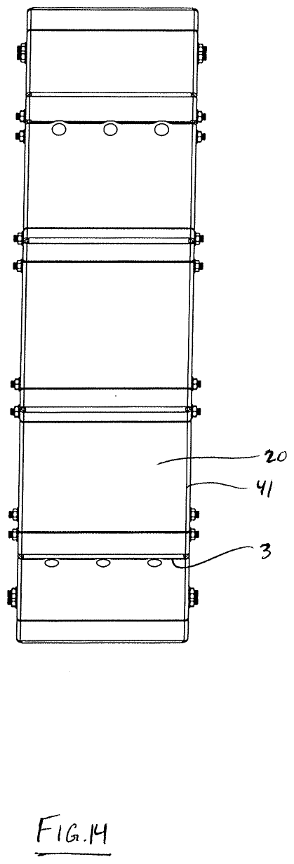

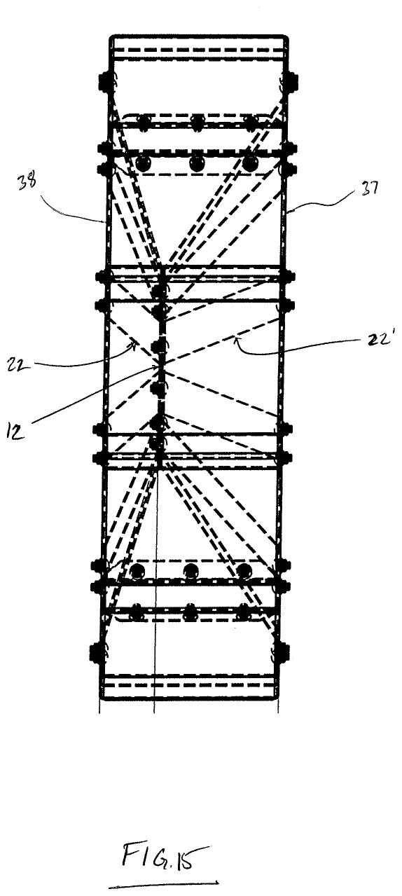

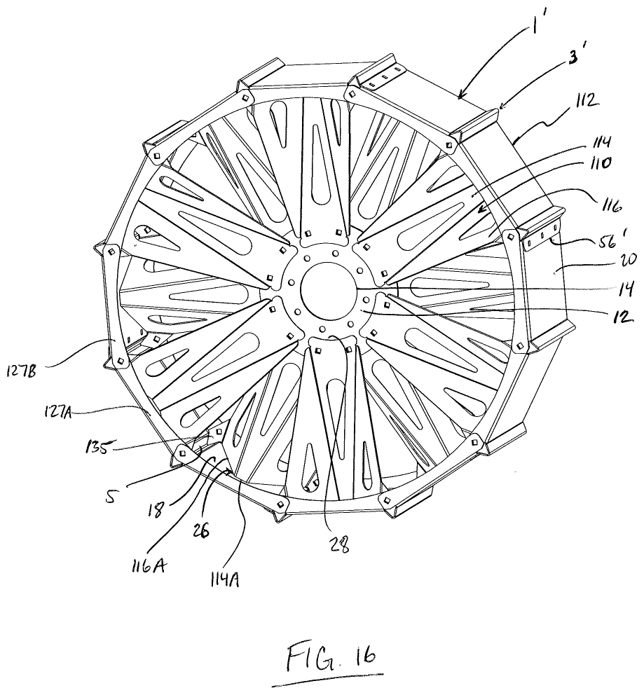

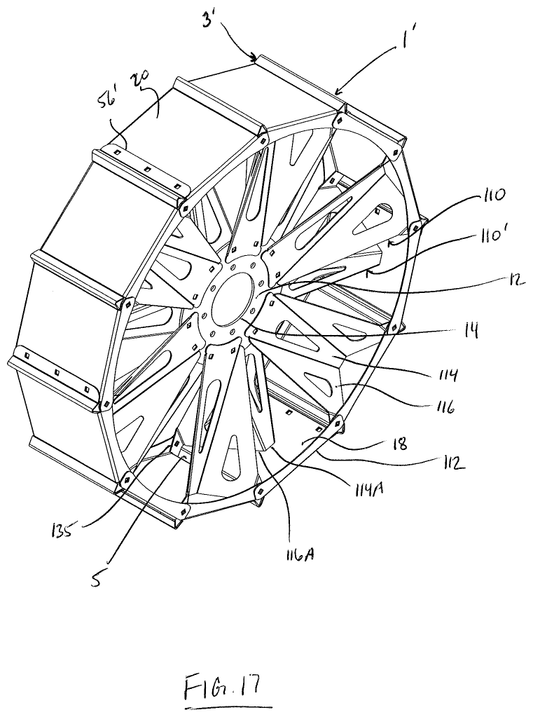

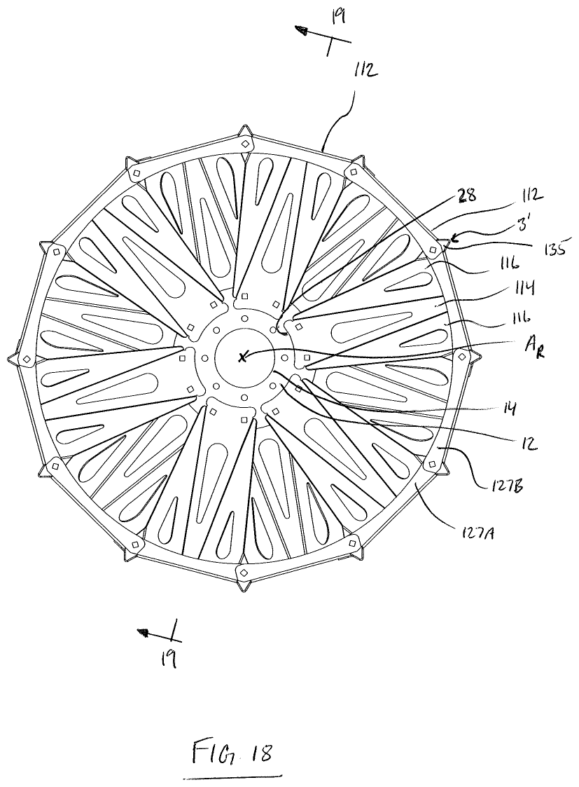

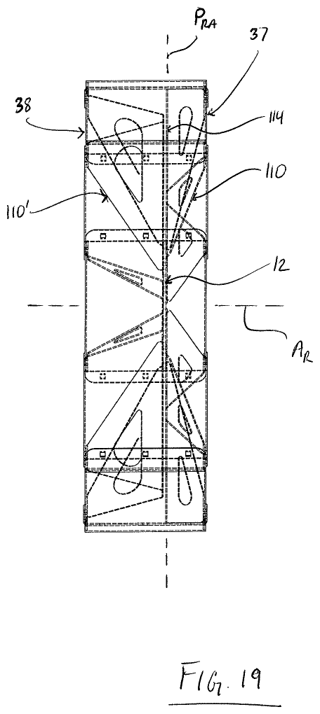

The second illustrated arrangement of kit of FIGS. 16-_ shows a different arrangement of spoke component 110 and outer rim component 112 as compared to the first illustrated arrangement of kit of FIGS. 1-15.

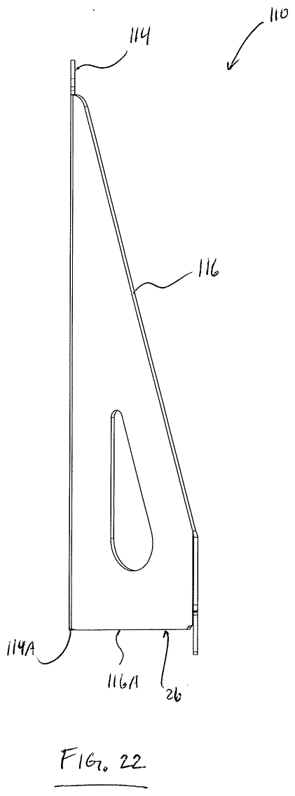

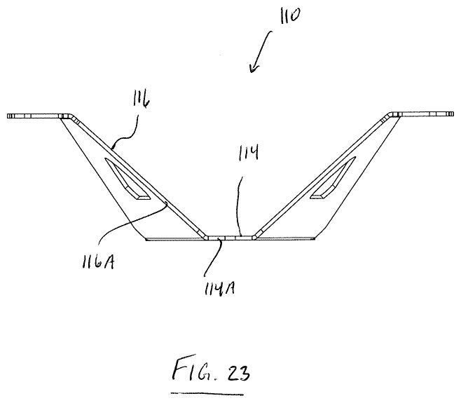

More specifically, and referring to FIGS. 21-24, the spoke component 110 of the second arrangement of kit differs from that of the first in that it is channel-shaped so as to include a base wall 114 and an opposite pair of sidewalls 116 disposed on a common side of the base wall, so as to be projecting from the base wall 114 in a generally common direction. In comparison, the spoke components 22, 22′ of the first arrangement which have a common design but different depth have a bar-like intermediary portion 101 which is planar.

Still referring to FIGS. 21-24 but also to FIGS. 16-17 and 19 of wheel 1′, the base wall 114 is planar and is adapted to lie in a radial plane PRA of a rotational axis AR of the wheel 1′ defined at the central opening 14 of the hub component, that is the rotational axis which is normally defined by the shaft received through the opening 14. The sidewalls 116 each define an edge 116A generally at a first end 26 of the spoke component that is adapted to abut an inner surface 18 of the outer rim component 112 in proximity to which that spoke component connects. The edges 116A are adapted to extend in the width direction of the wheel from a generally central location on the inner surface 18 to one of transversely opposite sides 35, 36 of the outer rim component 112.

Similarly to the sidewalls 116, the base wall 114 also defines an edge 114A generally at the first end 26 of the spoke component 110 that is adapted to abut the inner surface 18 of the outer rim component 112. Therefore the edges 114A and 116A lie in a common plane which is arranged substantially perpendicular to the radial plane in which the base wall 114 lies and substantially coplanar with the inner surface 18 of the outer rim component so as to be in butting engagement therewith. Furthermore, each spoke component 110 is in contact at the first end 26 thereof with the inner surface of an outer rim component to which that component 110 connects.

The sidewalls 116 diverge from the base wall 114 so that the channel is generally V-shaped, as more clearly shown in FIG. 23, and such that the sidewalls 116 are adapted to extend in both the width and circumferential directions of the wheel such that the edges 116A of the sidewalls are also adapted to extend in the circumferential direction of the wheel in abutment with the inner surface of said at least one outer rim component.

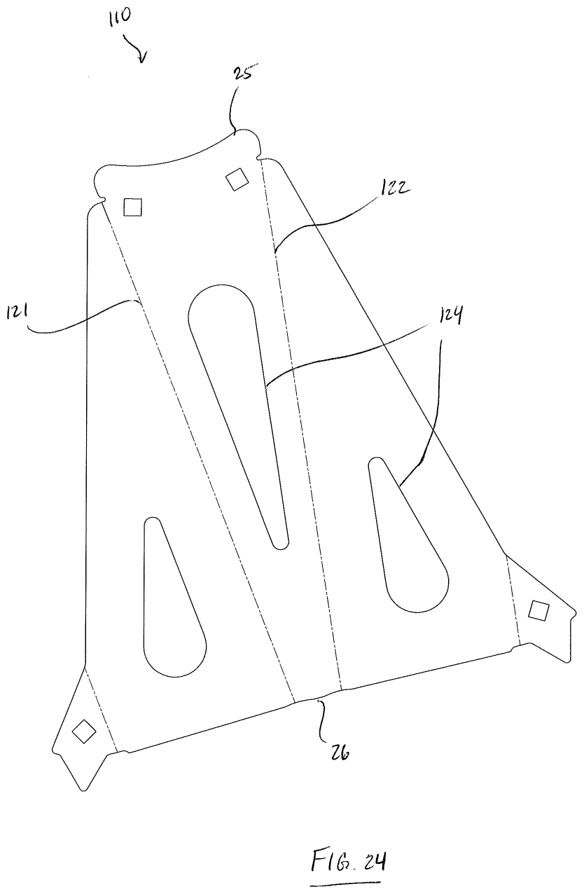

The spoke component 110 is formed from a flat blank like that shown in FIG. 24 which is cut from sheet metal and is generally trapezoidal in shape. The blank is bent along non-parallel folding axes 121, 122 which converge in a direction from a second end 28 of the spoke component to the first end 26. The axes 121, 122 delimit the base wall 114, and each of the walls 114, 116 are generally triangular in shape (the base wall 114 is more so trapezoidal in shape). Apertures 124 are provided in the base wall 114 and sidewalls 116 to reduce mass of the spoke component without substantially affecting its strength.

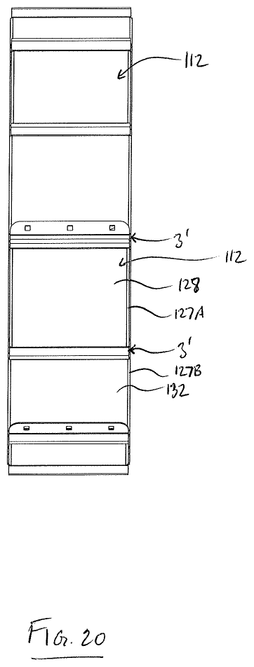

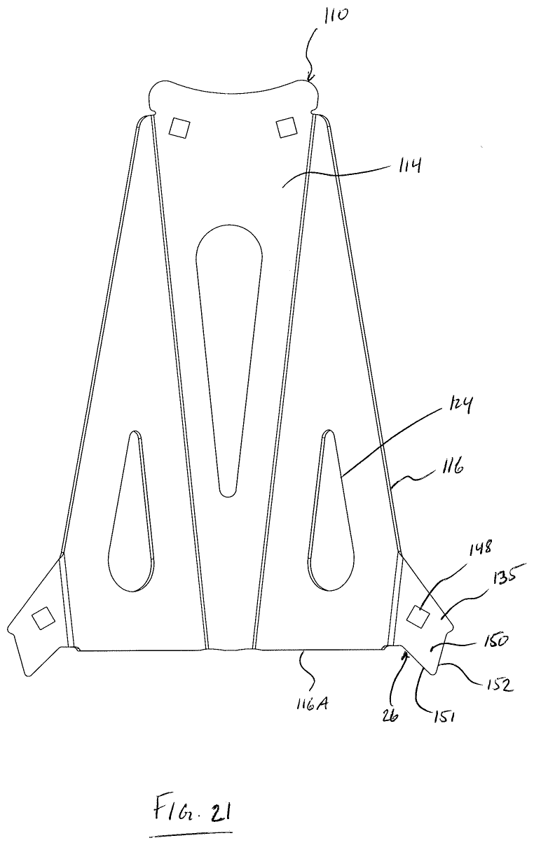

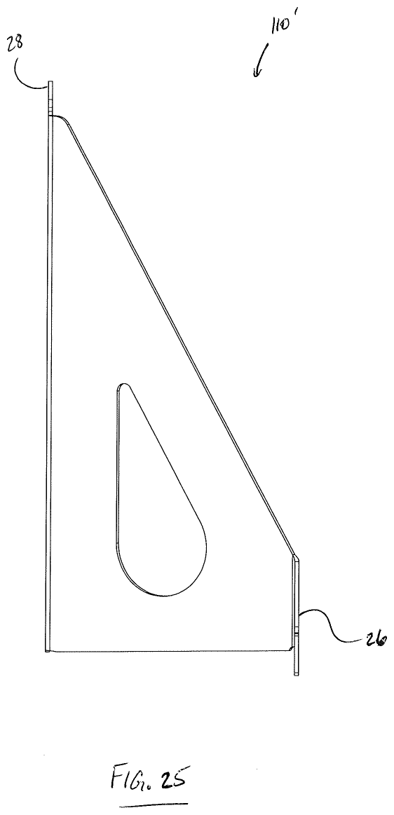

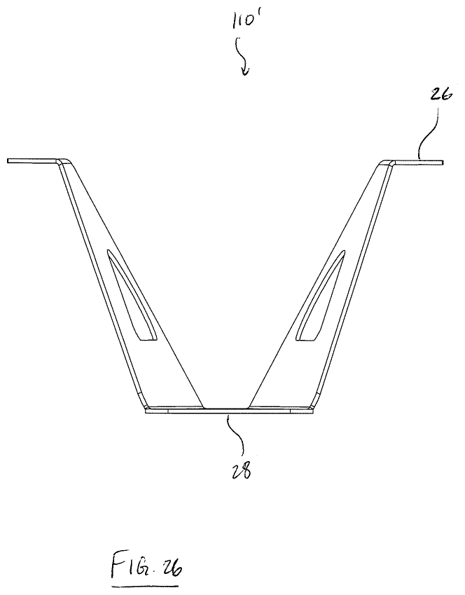

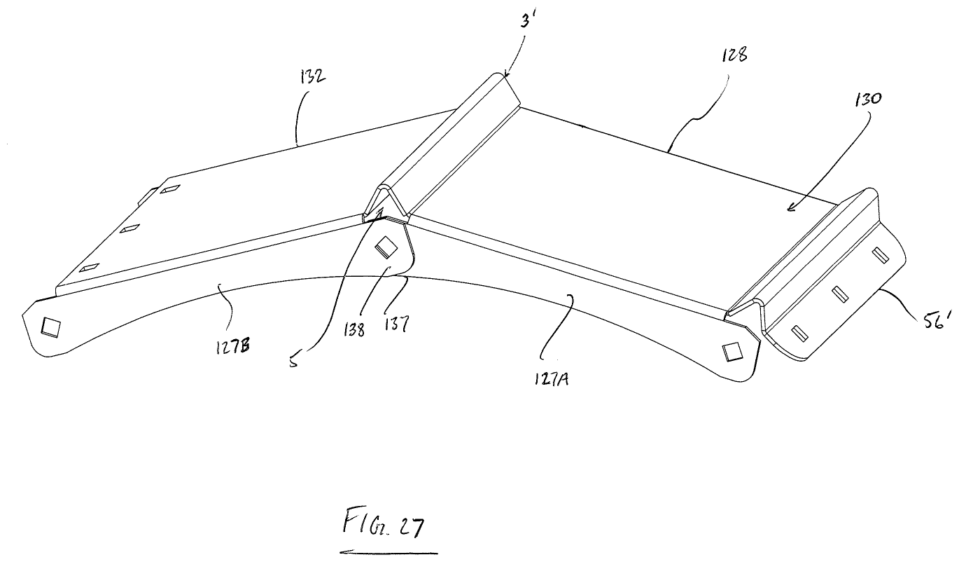

The second arrangement of kit has a set of spoke components 110 for the inner side 37 of the wheel, which is adapted to be distal to the vehicle on which the wheel is mounted, and a slightly different set of spoke components 110′ for the outer side 38 of the wheel which are substantially the same in design except that a depth between the first and second ends 26, 28 is greater as shown in FIGS. 25-26 so that the hub component is offset from a center of the wheel towards the inner side 37. This is similar to the first arrangement of kit where the hub component 12 also is offset towards one side of the wheel from the width-wise center. In the second arrangement of kit, the hub component 12 is disposed intermediate the inner and outer sets of spoke components which mount on either side of the hub component, as more clearly shown in FIG. 19.

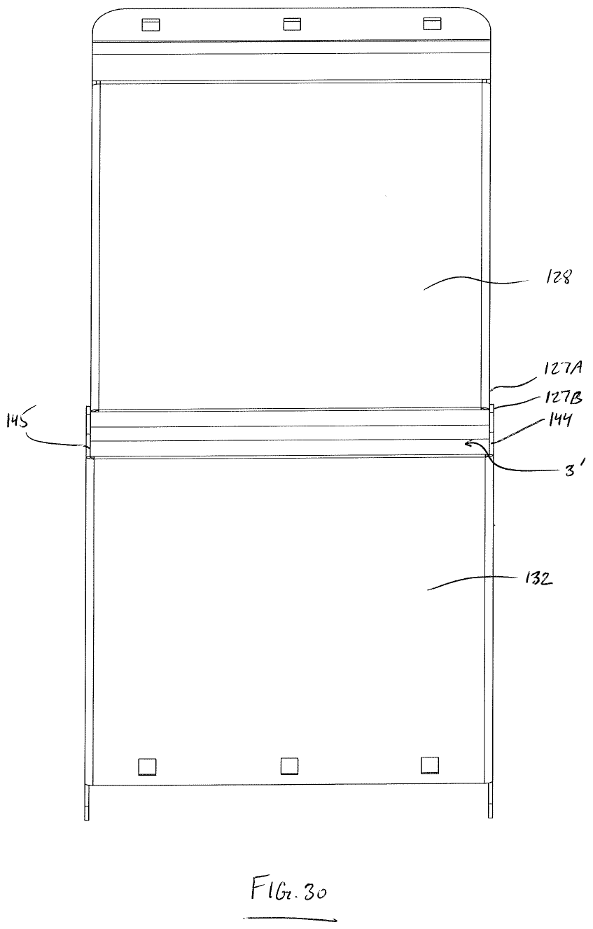

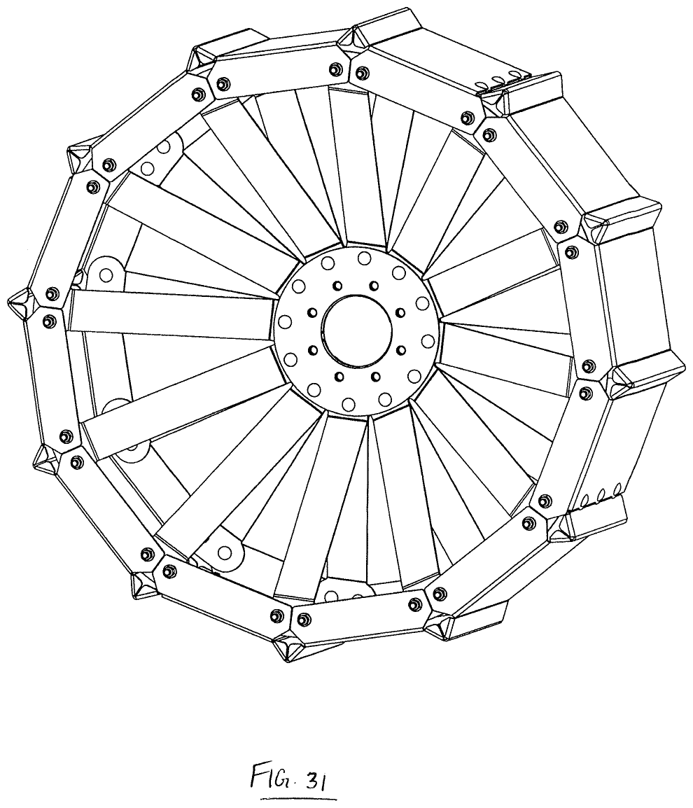

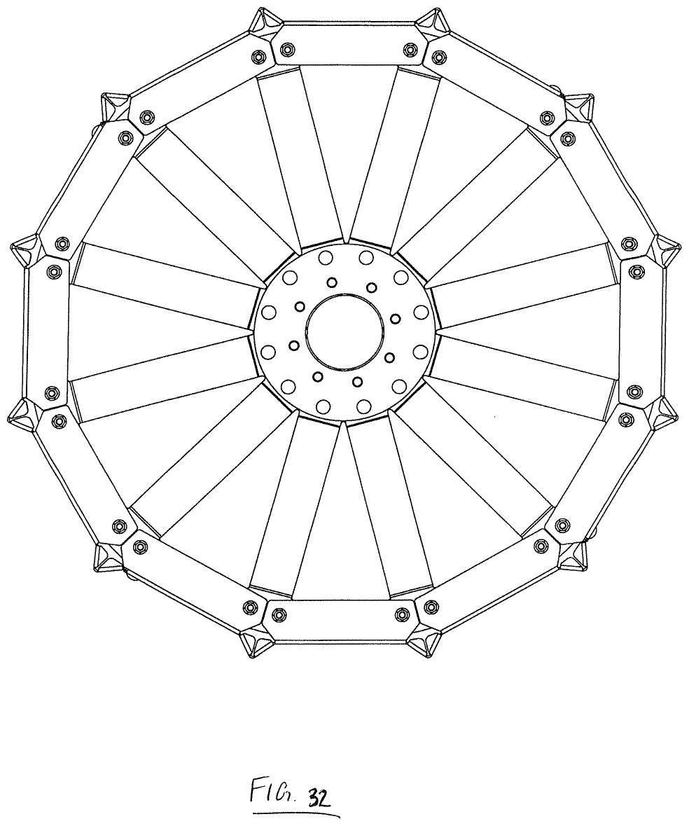

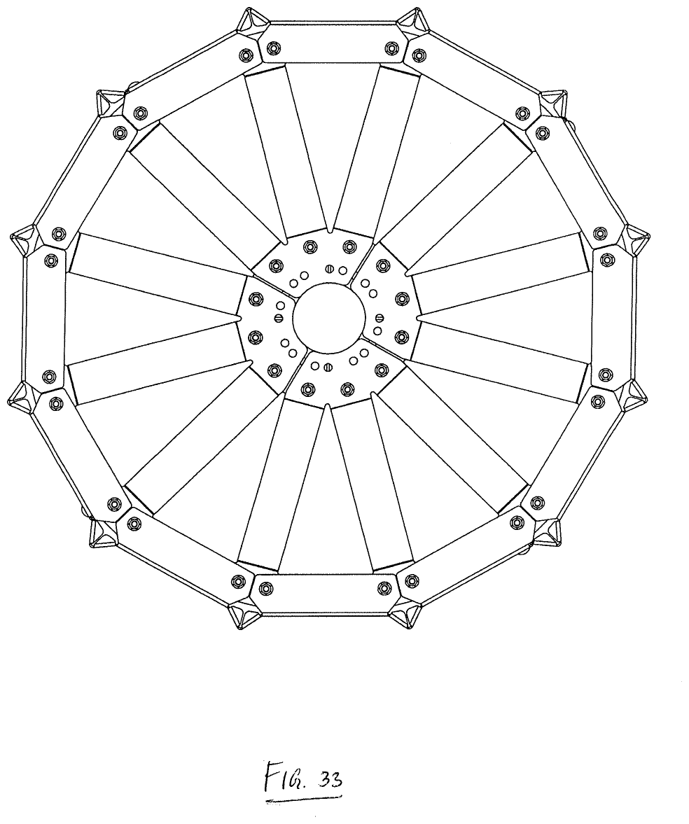

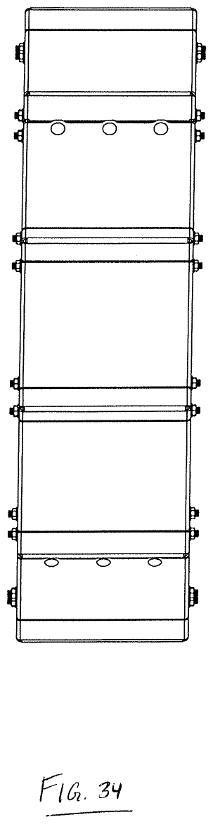

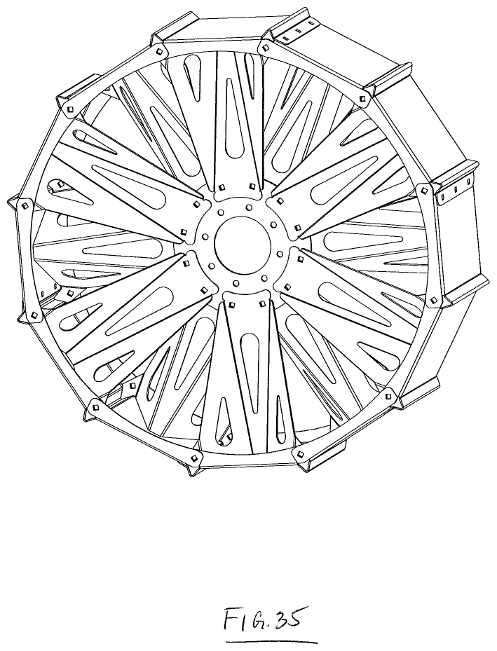

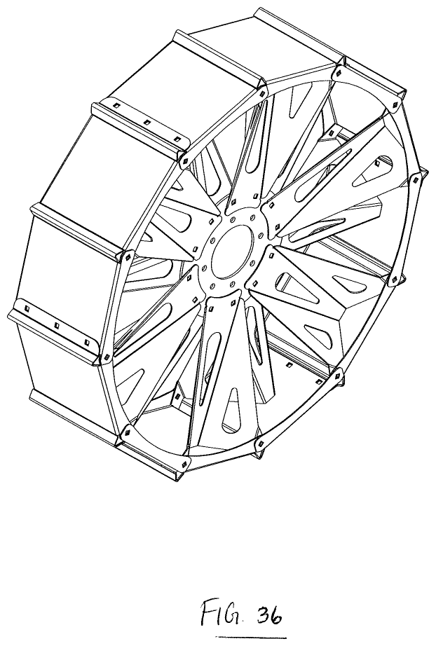

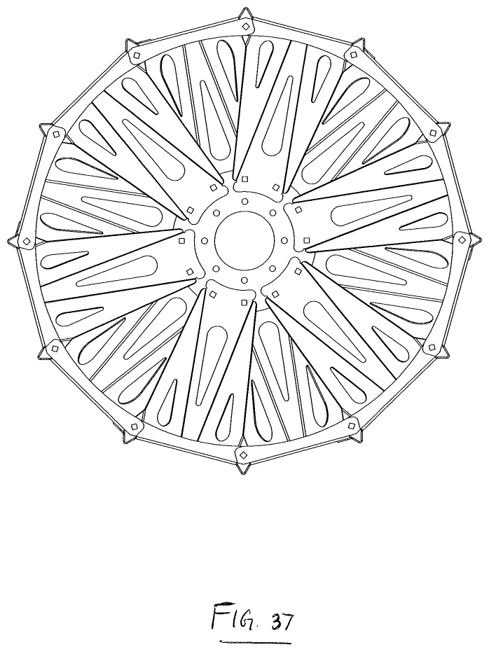

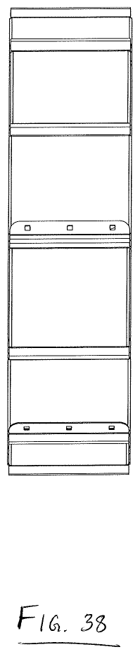

Turning now to FIGS. 27-30, the outer rim component 112 of the second arrangement of kit substantially differs from that of the first in that (i) spoke coupling flanges 127A of a first one 128 of a series of main bodies of a central portion 130 of the outer rim component are adapted to overlap spoke coupling flanges 127B of a second next one 132 of the main bodies in a curved condition of the outer rim component, so that a common fastener can be used to interconnect adjacent overlapping flanges 127A, 127B at a common location on the spoke component 110, and (ii) outwardly-projecting fins 3′ formed by the outer rim component 112 are reinforced or supported a tab 135 carried on the spoke component 110.

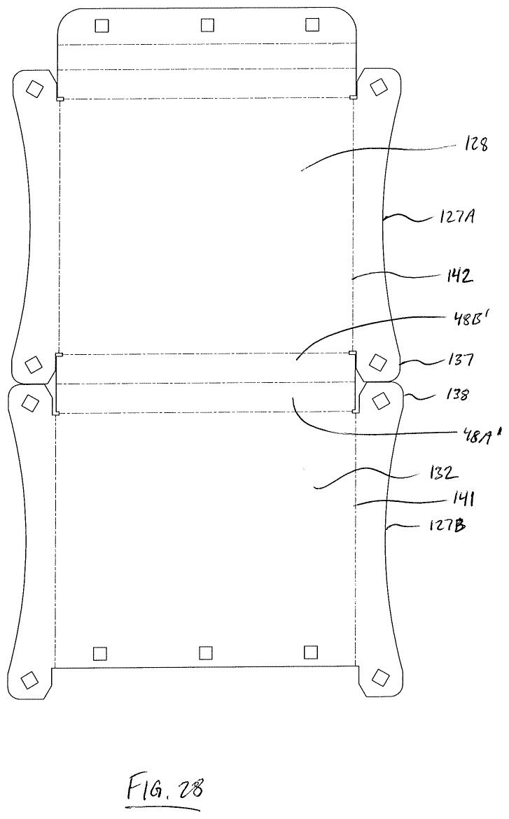

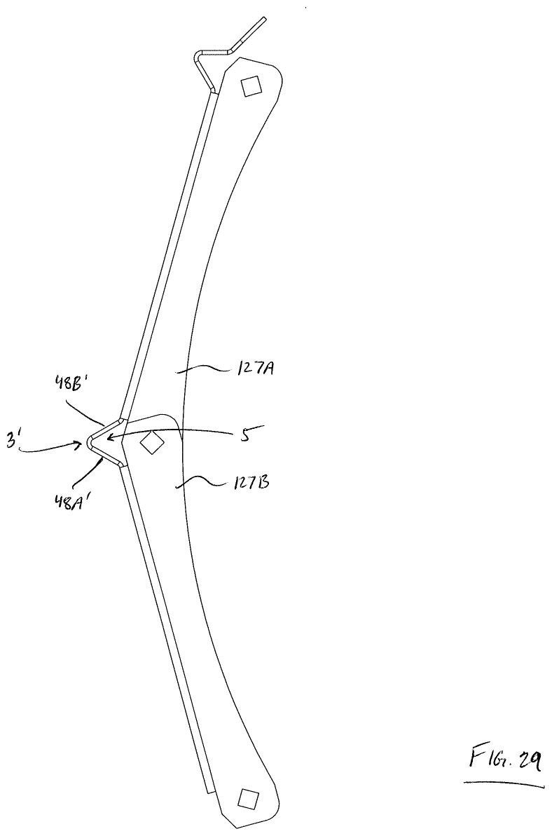

More specifically, in regard to item (i) in the previous paragraph, and referring to FIG. 28, spoke coupling tabs 127A, 127B have substantially a common design but those indicated at 127B are located further transversely outwardly of those at 127A so that their ends 137, 138 can overlap at location of the fin 3′ formed by strips 48A′, 48B′ by sizing the second main body 132 larger in width than the first main body 128. This acts to locate folding axes 141, at which the coupling flanges 127B are interconnected to the second main body 132, further transversely outwardly of those indicated at 142 at which the coupling flanges 127A interconnect with the first main body 128. A width of the second main body 132 defined by a distance measured between the folding axes 141 is substantially equal to a width of the fin 3′ which spans the full width of the wheel 1′, and a width of the first main body 128 defined by a distance measured between the folding axes 142 is slightly smaller than the width of the fin 3′ so that, as more clearly shown in FIG. 30, in the rim forming condition the spoke coupling flanges 127A which project radially-inwardly from the main body 128 are substantially radially in-line with transversely opposite sides 144, 145 of the fin 3′.

Turning now with more specificity to item (ii) as mentioned in the prior paragraph to the immediately previous one, each triangular fin 3′ defines an interior void 5 which is open adjacent the inner surface 18 of the outer rim component 112 so as to be adapted to open to an interior of the wheel which is delimited both width-wise and circumferentially by the interconnected outer rim components. Like the fin 3′, the void 5 also is triangular in shape across the width of the wheel. The first end 26 of each spoke component 110, which is connectable to the outer rim component 112, defines a tab 135 which is adapted for matable insertion into the void 5 to support the fin. The tab 135 also serves as a connection location for the spoke component 110 to the outer rim component 112 at the coupling flanges 127A-B and thus defines an aperture 148 for receiving a fastener. Each spoke component 110 is provided with a pair of the tabs 135 so that each spoke component is connected to an adjacent pair of circumferentially spaced connection locations spaced along the rim of the wheel.

The tab 135 is connected to a free side of the sidewall 116 distal to the base wall 114 and is located adjacent the abutment edge 116A. As the void 5 of the outer rim component 112 is triangular in shape from the inner side to the outer side of the wheel, the tab 135 has a triangular-shaped insertion portion 150 projecting beyond the edge 116A that is sized and shaped substantially the same as the cross-section of the void 5. Thus the tab 135 defines a pair of converging edges 151, 152, adapted to be located radially outwardly beyond the end 26 of the spoke component substantially defined by the edges 114A and 116A, which engage each of the strips 48A′-B′ from the inner side of the outer rim component 112. As such, the tabs 135 supporting the fins 3′ from an interior side of the wheel reinforces the fin 3′ against radially inward compression forces.

Another difference between the two arrangements of the kit of the present invention is that in the second arrangement each spoke component 110, 110′ of a pair which is interconnecting the respective outer rim component 112 and the hub component 12 is adapted to be angularly offset from the other one of the pair of spoke components about the central opening 14 of the hub component. In this manner, each circumferentially adjacent pair of connection locations of the outer rim component(s) is connected to one spoke component whether on the inner side or the outer side of the wheel.

Also, in the second arrangement a rim interconnection flange 56′ overlaps an outer surface 20 of the next outer rim component so as to be located externally of the wheel.

Each of the components can be manufactured from sheet metal which is cut into the desired shape using for example a laser cutting machine. Each cut piece is then processed into the respective end product by bending so that no welding is required to form same. The resultantly formed components of the wheel can then be interconnected by simple fasteners without welding. Thus the whole of the wheel including its constituent parts and the assembly of the kit does not require any welding for formation, such that the whole of the wheel is substantially resistant to corrosion when for example constituent parts are galvanized before being interconnected in the wheel-forming condition of the kit. The metal from which the constituent parts is made may be, for example, aluminum.

The scope of the claims should not be limited by the preferred embodiments set forth in the examples but should be given the broadest interpretation consistent with the specification as a whole.

1. A kit for forming a wheel comprising:
a hub component in the form of an annular body defining a central opening for receiving a shaft on which the wheel is to be mounted;
at least one outer rim component adapted to form a substantially circular periphery of the wheel and defining an inner surface adapted for facing generally radially inwardly of the wheel towards the hub component and opposite to the inner surface, said at least one outer rim component defining an outer surface of the wheel for engaging a ground surface; and
a plurality of spoke components each including at least one leg extending from a first end of a respective one of said at least one leg which is connectable to said at least one outer rim component in proximity of the inner surface thereof to a longitudinally spaced second end of a respective one of said at least one leg which is connectable to the hub component for interconnecting the hub component and said at least one outer rim component, such that the spoke components are adapted to extend generally radially of the wheel between said at least one outer rim component and the hub component each of the spoke components being arranged at a respective angular position about the hub component.

2. The kit of claim 1 wherein said at least one outer rim component comprises at least one flange adapted to project generally radially inwardly from the inner surface of said at least one outer rim component to provide a mounting location for connecting the first end of the respective said at least one leg of each spoke component.

3. The kit of claim 1 wherein said at least one outer rim component comprises a central portion extending between longitudinally opposite ends and defining the outer surface and the inner surface, the central portion being bendable in a longitudinal direction thereof, in which the central portion is adapted to follow a circumference of the wheel, from a substantially flat condition suited for shipping to a curved condition in which the central portion forms a curvature adapted to follow the circumference of the wheel.

4. The kit of claim 3 wherein the central portion of said at least one outer rim component comprises a series of planar bodies arranged end to end, adjacent ones of the series of the planar bodies being interconnected by a joining portion defining a transverse bending axis to the longitudinal direction of the central portion so that each one of the planar bodies is movable about the transverse bending axis relative to the next one of the planar bodies.

5. The kit of claim 3 wherein said at least one outer rim component comprises a rim interconnection flange coupled at a first one of the ends of the central portion that is bendable in the longitudinal direction relative to the central portion so as to be adapted to follow the circumference of the wheel, the rim interconnection flange being adapted for overlapping a second one of the ends of the central portion such that the first and second ends of the central portion of said at least one outer rim component are interconnectable to form the periphery of the wheel.

6. The kit of claim 1 wherein each of said at least one outer rim component is interconnected with the hub component by a pair of the spoke components each connected to the respective said at least one outer rim component at a spaced location from the other relative to a width direction of the wheel, and wherein the first and second ends of said at least one leg of a respective one of the pair of the spoke components are offset from one another in a depth direction of the respective spoke component, which is adapted to lie in a width direction of the wheel, so that the second ends of the legs of the pair of the spoke components meet at a common location for subsequently connecting to the hub component.

7. The kit of claim 6 wherein the first and second ends of said at least one leg of the respective one of the pair of the spoke components are offset by a different distance in the depth direction thereof so that the hub component is offset from a center of the wheel with respect to the width direction thereof.

8. The kit of claim 6 wherein each spoke component is channel-shaped so as to include a base wall and an opposite pair of sidewalls disposed on a common side of the base wall, the base wall being planar and adapted to lie in a radial plane of a rotational axis of the wheel defined at the central opening of the hub component, and the sidewalls each defining an edge generally at the first end of the spoke component that is adapted to abut the inner surface of said at least one outer rim component and to extend in the width direction of the wheel from a generally central location on the inner surface to a side of said at least one outer rim component.

9. The kit of claim 8 wherein the base wall also defines an edge generally at the first end of the spoke component that is adapted to abut the inner surface of said at least one outer rim component.

10. The kit of claim 8 wherein the sidewalls are adapted to extend in both the width direction of the wheel and a circumferential direction of the wheel such that the edges of the sidewalls are also adapted to extend in the circumferential direction of the wheel in abutment with the inner surface of said at least one outer rim component.

11. The kit of claim 6 wherein each spoke component of the pair interconnecting each of said at least one outer rim component and the hub component is adapted to be angularly offset from the other one of said pair of spoke components about the central opening of the hub component.

12. The kit of claim 1 wherein said at least one outer rim component is adapted to form one or more outwardly-projecting triangular fins extending in a width direction of the wheel and spaced from one another in a circumferential direction of the wheel, each fin defining an interior void which is open adjacent the inner surface of said at least one outer rim component so as to be adapted to open to an interior of the wheel, and the first end of each spoke component, which is connectable to said at least one outer rim component, defining a tab adapted for matable insertion into the void to support the fin.

13. A blank for forming a circumferential portion of a rim of a wheel, the rim having outwardly projecting fins extending in a width direction of the wheel, the blank comprising:
a main body having opposite longitudinally spaced apart ends and transversely spaced apart sides interconnecting the opposite ends, the main body defining an outer surface for engaging a ground surface;
a first transversely oriented strip connected at one of the ends of the main body in a manner defining a transverse folding axis about which the first strip is movable relative to the main body;
a second transversely oriented strip connected to the first strip opposite to the main body in a manner defining a transverse folding axis about which the second strip is movable relative to the first strip;
each of the first and second strips carrying tabs at transversely spaced positions thereon, each tab being foldable relative to a respective one of the first and second strips about a substantially longitudinally oriented folding axis;
a generally triangularly shaped cut-out being formed between a first one of the tabs on the first strip and a first one of the tabs on the second strip that are adjacent, which is partially delimited by opposing edges of the first tabs of the first and second strips, such that in a folded rim-forming condition of the blank in which the first and second strips are positioned to form a peak such that an outer surface of the first strip is inclined outwardly from the outer surface of the main body, such that one of the fins is formed, and in which condition the tabs are positioned substantially perpendicularly to an inner surface of a respective one of the first and second strips, said opposing edges are positioned facing one another so as to be adapted to engage one another.

14. The blank of claim 13 wherein the main body carries tabs at transversely spaced positions thereon which are foldable relative to the main body about substantially longitudinally oriented folding axes, each tab carried on the main body having edges which follow portions of triangularly shaped peripheries of the tabs carried on the first strip that are opposite from a respective one of the opposing edges defined by the tabs on the first strip, and each tab carried on the main body locating an aperture which is adapted to lie generally radially in-line with the tabs carried on the first strip when the tabs carried on the main body are positioned substantially perpendicularly to an opposite inner surface of the main body for receiving a fastener to interconnect the blank arranged in the folded rim-forming condition with another component of the wheel.

15. The blank of claim 14 wherein there is provided first and second sets of the main body with the tabs, the first strip with the tabs and the second strip with the tabs, the main body of the first set being connected to the second strip of the second set opposite to the first strip of the second set in a manner defining a transverse folding axis about which the main body of the first set is movable relative to the second strip of the second set, each tab carried on the main body of the first set having edges which follow portions of triangularly shaped peripheries of the tabs carried on the second strip of the second set that are opposite from a respective one of the opposing edges defined by the tabs on the second strip of the second set, and distal edges of the tabs carried on the main body of the first set that are respectively adjacent the periphery-following edges thereof being adapted for engaging distal edges of the tabs carried on the main body of the second set that are respectively adjacent the periphery-following edges thereof in the folded rim-forming condition of the blank, in which the tabs carried on the main body of the first and second set are positioned substantially perpendicularly to the inner surface of the corresponding main body, so that the distal edges of the tabs carried on a respective one of the main bodies of the first and second sets are positioned facing one another so as to be adapted to engage one another.

16. The blank of claim 15 further including a transversely oriented rim interconnection flange which is connected to the second strip of the first set opposite to the first strip of the first set in a manner defining a transverse folding axis about which the rim interconnection flange is movable relative to the second strip of the first set, the rim interconnection flange being adapted to overlap a free end of a main body of another like blank for facilitating interconnection of a plurality of the blanks to form the rim of the wheel.
